(19) United States
(12) Patent Application Publication
(10) Pub. No.: US 2023/0050873 A1
(43) Pub. Date: Feb. 16, 2023

(54) INTELLIGENT REPLACEMENT OF VIDEO CONTENT SEGMENTS

(71) Applicant: DISH Network L.L.C., Englewood, CO (US)

(72) Inventor: Kate LANDOW, Englewood, CO (US)

(73) Assignee: DISH Network L.L.C., Englewood, CO (US)

(21) Appl. No.: 17/445,109

(22) Filed: Aug. 16, 2021

(51) Int. Cl. H04N 21/234; H04N 21/81; H04N 21/845; H04N 21/25; H04N 21/258

(52) U.S. Cl. CPC H04N 21/23424; H04N 21/812; H04N 21/8456; H04N 21/251; H04N 21/25883

(57) ABSTRACT

A video services system and related operating methods are disclosed here. A method of operating the video services system involves: processing encoded video data that conveys an original version of video programming having primary video content divided into primary video segments, and having secondary video content in a secondary video segment arranged adjacent to at least one of the primary video segments; obtaining a primary program identifier that uniquely identifies the primary video content; and reviewing information linked to the obtained primary program identifier. In response to the reviewing, a replacement video segment is identified to replace the secondary video segment. The secondary video segment is replaced with the replacement video segment.

### TECHNICAL FIELD

Embodiments of the subject matter described herein relate generally to a system and related methodology for processing and managing video content. More particularly, embodiments of the subject matter relate to a technique for intelligently replacing certain segments of a video program with different video content.

### BACKGROUND

Many consumers of video content receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded video programming data is sent via a cable or wireless data link to the viewer's home, where the video data is ultimately decoded by the STB. The decoded signals can then be viewed on a television or other appropriate display as desired by the viewer. Additionally, streaming and on-demand video can be provided via the Internet, mobile networks, or the like. In this regard, video content can be delivered from a content server to a user device (e.g., a personal computer, a smartphone device, a tablet device) upon request by the user.

Although a video program such as a movie or a television show can be broadcast or otherwise presented in an uninterrupted manner, in many cases the program is divided into shorter segments that are separated by segments of secondary content (also referred to herein as interstitial content). In practice, the secondary video content is different than the primary video program content, and it can include previews of other video programs, promotional content, commercials, etc. Ideally, the type, genre, and context of the secondary content is suitable and appropriate for viewers of the primary video program. For example, if the video program is a movie that includes violence, profanity, and mature themes, then the secondary content provided with the movie can be suitable for an adult audience. In contrast, if the video program is a cartoon or educational program directed at children under the age of ten, then the secondary content provided with the program should be age-appropriate and suitable for young children. In practice, however, the secondary content (such as commercials) may not always be contextually “matched” to the target viewing audience of the primary video program. Mismatched secondary content can be annoying and frustrating to some viewers, and a cause of concern for other viewers, such as parents who monitor the video content viewed by their children.

Accordingly, it is desirable to have an improved and intelligent methodology for automatically identifying inappropriate or unsuitable segments of a video program, and for automatically replacing inappropriate or unsuitable segments with more appropriate and/or relevant content. Furthermore, other desirable features and characteristics will become apparent from the subsequent detailed description and the appended claims, taken in conjunction with the accompanying drawings and the foregoing technical field and background.

### BRIEF SUMMARY

A method of operating a video services system is presented here. The method involves: processing encoded video data that conveys an original version of video programming having primary video content divided into primary video segments, and having secondary video content in a secondary video segment arranged adjacent to at least one of the primary video segments; obtaining a primary program identifier that uniquely identifies the primary video content; reviewing information linked to the obtained primary program identifier; in response to the reviewing, identifying a replacement video segment to replace the secondary video segment; and replacing the secondary video segment with the replacement video segment.

A computer-implemented video processing system is also disclosed herein. The system processes encoded video data that conveys an original version of video programming having primary video content divided into primary video segments, and having secondary video content in a secondary video segment arranged adjacent to at least one of the primary video segments. The video processing system includes: at least one processor device; and non-transitory computer readable media operatively associated with the at least one processor device. The computer readable media has executable instructions configurable to cause the at least one processor device to perform a method that involves the steps of: obtaining a primary program identifier that uniquely identifies the primary video content; reviewing information linked to the obtained primary program identifier; in response to the reviewing, identifying a replacement video segment to replace the secondary video segment; and communicating the replacement video segment to replace the secondary video segment during presentation at a user presentation device.

Also disclosed herein is a method of operating a video services system configured to process encoded video data that conveys an original version of video programming having primary video content divided into primary video segments, and having secondary video content in a secondary video segment arranged adjacent to at least one of the primary video segments. The method involves the steps of: obtaining a primary program identifier that uniquely identifies the primary video content; reviewing information linked to the obtained primary program identifier; in response to the reviewing, identifying a replacement video segment to replace the secondary video segment; and communicating the replacement video segment to replace the secondary video segment during presentation at a user presentation device.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates an exemplary embodiment of a video delivery system that performs intelligent replacement of video segments in a video program;

FIG. 2 is a schematic representation of a video program having primary video segments interspersed with secondary video segments; and

FIG. 3 is a flow chart that illustrates an exemplary embodiment of a process for the intelligent replacement of video content segments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content conveyed in a video stream, the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based streaming content delivery system, a cellular network delivery system, or the like. The disclosed subject matter relates to a system and related methodologies for processing an original version of video programming that includes primary video content and secondary video content (e.g., interstitial content, commercials, advertisements, marketing segments), wherein the processing is intended to identify viewer-appropriate content that can be used to replace at least some of the secondary video content. For example, if the primary video content is intended for a young viewing audience (children or toddlers), then the disclosed system determines or identifies age-appropriate video segments to replace the secondary video content segments contained in the original version of the video programming. The exemplary embodiment of the system described here leverages program identifiers that uniquely identify the primary video content and/or the secondary video content, wherein the program identifiers can be reviewed to determine appropriate replacement video content that “matches” the primary video content.

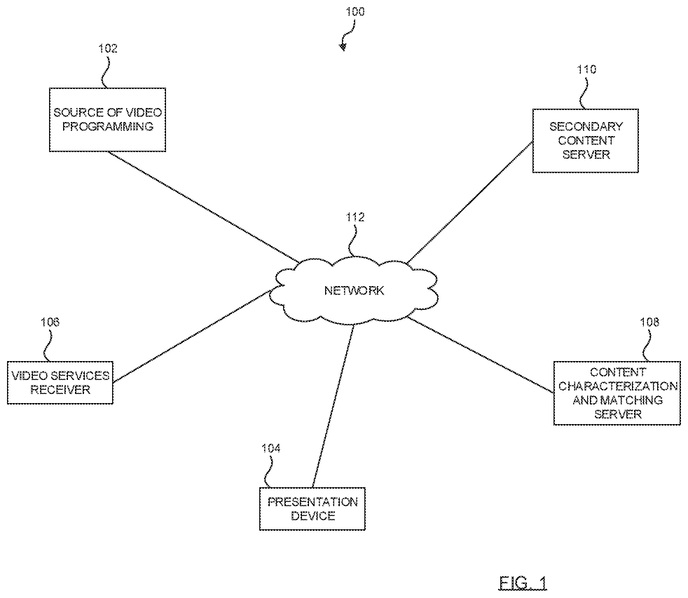

FIG. 1 is a block diagram that illustrates an exemplary embodiment of a video services system 100 that is suitably configured to support the techniques and methodologies described in more detail below. It should be appreciated that the block diagram shown in FIG. 1 represents a simplified version of the system 100, for ease of description and clarity. A practical implementation of the system 100 will typically include additional components and functionality that need not be shown or described here.

The system 100 generally includes, without limitation: at least one source of video programming 102 (referred to in the singular form herein for the sake of convenience); a presentation device 104; a video services receiver 106 or other form of customer equipment that is capable of receiving, processing, and rendering video content; a computer-implemented server system 108 that is programmed and operated to perform content characterization and matching in the manner described in more detail below; and a computer-implemented server system 110 that is programmed and operated to maintain secondary video content that can be accessed by, or delivered to, client devices or systems on demand. The main components of the system 100 are depicted as remotely located computing devices in FIG. 1. In certain embodiments, however, a plurality of the system components can be physically located in the same facility. Moreover, a plurality of the system components can be implemented together in a single piece of computer-based hardware if so desired (for example, the server system 108 and the server system 110 can be implemented together as two functional modules of one hardware system).

In certain embodiments, the source of video programming 102, the presentation device 104, the video services receiver 106, the server system 108, and the server system 110 communicate using a data communication network 112. For the sake of brevity, conventional techniques related to satellite, cable, and Internet-based communication systems, video broadcasting systems, data transmission, signaling, network control, and other functional aspects of the systems (and the individual operating components of the systems) may not be described in detail herein. The data communication network 112 is any digital or other communications network capable of transmitting signals, data, and/or messages between senders and receivers within the system 100. In various embodiments, the network 112 includes any number of public or private data connections, links or networks supporting any number of communications protocols. The network 112 may include the Internet, for example, or any other network based upon TCP/IP or other conventional protocols. In various embodiments, the network 112 also incorporates a wireless and/or wired telephone network, such as a cellular communications network for communicating with mobile phones (including, but not limited to, 5G networks), personal digital assistants, and/or the like. The network 112 may also incorporate any sort of wireless or wired local area networks, such as one or more IEEE 802.3 and/or IEEE 802.11 networks.

The system 100 may include or cooperate with one or multiple sources of video programming 102; FIG. 1 and this description refer to only one source of video programming 102 for the sake of simplicity. Moreover, a given video services provider (e.g., a satellite video provider, a cable television provider, a telecommunication services provider, or the like) could maintain, provide, or otherwise cooperate with one or multiple sources of video programming 102 designed to support any number of subscribers.

In certain embodiments, the source of video programming 102 may be deployed as a head end facility and/or a satellite uplink facility for the system 100. In some embodiments, the source of video programming 102 may include or cooperate with one or more web-based content delivery applications, services, or providers. The source of video programming 102 generally functions to control content, signaling data, programming information, and other data sent to any number of receiving components. In practice, the source of video programming 102 may also provide content and data that can be used to populate an interactive electronic program guide (EPG) generated by the video services receiver 106.

The source of video programming 102 includes one or more data processing systems or architectures that are capable of producing signals that are transmitted to customer premise equipment, mobile devices, computer systems, or the like. In various embodiments, the source of video programming 102 represents a satellite, cable, or other content distribution center having: a data control system for controlling content, signaling information, blackout information, programming information, and other data; and a control system for transmitting content, signaling information, blackout information, programming information, and other data using high-bandwidth links. These systems may be geographically, physically and/or logically arranged in any manner, with data control and uplink control being combined or separated as desired.

Each presentation device 104 supported by the system 100 is suitably configured and arranged to perform at least the following functions: playing locally stored video content; playing streaming media content; playing replacement video segments; and other routine or conventional functions that may be unimportant in the context of this description. A presentation device 104 may also be configured and arranged to support the recording and saving of video events. In this regard, a presentation device 104 can be realized as a devoted DVR device, a remote (e.g., cloud-based) DVR system, or as another piece of hardware that incorporates video recorder functionality. In typical deployments, the presentation device 104 can be implemented as a standalone DVR device, a set top box, a smart television set, a streaming media appliance, or any piece of hardware that receives and handles video content that is broadcast or otherwise delivered by a video service provider. In certain embodiments, a presentation device 104 or its functionality as described herein can be realized with: a personal computer (e.g., a laptop, desktop, tablet, or other form factor); a mobile phone; a personal media player; a video game console or device; a vehicle-based entertainment system; or the like. In this regard, the methodologies described here can also be utilized with a presentation device 104 that lacks video recording functionality, as long as the device is capable of processing and playing video events (e.g., a saved video file, streaming video content, broadcast video content) in the manner described in more detail herein.

In accordance with an exemplary use case, the presentation device 104 handles video events in a conventional manner. In accordance with certain embodiments, video content received and processed by the presentation device 104 may be formatted in compliance with one of the MPEG encoding standards, such as MPEG-2 or MPEG-4, as may be used in DBS systems, MPEG-DASH for use with streaming applications, terrestrial Advanced Television Systems Committee (ATSC) systems or cable systems. However, different audio and video data formats and encoding schemes may be utilized in other implementations.

The video services receiver 106 represents one exemplary embodiment of a video presentation system, device, component, or module that is suitable for use in the system 100. The video services receiver 106 can be realized as any device, system or logic capable of receiving signals from the source of video programming 102. Accordingly, the video services receiver 106 may include a receiver interface to receive data associated with video services, including any number of video events that are provided by various video providers. More specifically, the video services receiver 106 is suitably configured to receive original versions of video programming from the source of video programming 102. In accordance with certain embodiments, the receiver interface may also be utilized to access and receive secondary video content from the server system 110.

To support traditional video delivery functions, the video services receiver 106 is capable of providing demodulated content to a customer via an associated display element (not shown in FIG. 1). Accordingly, the video services receiver 106 may include a suitable display interface for the display, where the display interface facilitates presentation of video and image content on the display. In various embodiments, the video services receiver 106 is implemented as a set-top box (STB) as commonly used with digital video broadcasting, satellite, or cable television distribution systems. In other embodiments, however, the functionality of the video services receiver 106 may be commonly housed within the display element itself. In still other embodiments, the video services receiver 106 a portable device that may be transportable with or without a display. The video services receiver 106 may also be suitably configured to support broadcast television reception, video game playing, personal video recording and/or other features as desired.

During typical operation, the video services receiver 106 receives video programming (broadcast events, on-demand video events, streaming media, emergency broadcasts, etc.), signaling information, and/or other data via the network 112. The video services receiver 106 then demodulates, decompresses, descrambles, and/or otherwise processes the received digital data, and then converts the received data to suitably formatted video signals that can be rendered for viewing by the customer on the associated display and/or on the presentation device 104. The video services receiver 106 may also be capable of receiving web-based content via the network 112, the Internet, etc., and may also be capable of recording and playing back video content. In certain scenarios, the video services receiver 106 can be utilized as a playback system for digital media files (e.g., streaming media content) that convey recorded versions of original video program events. For example, an end user device (e.g., the presentation device 104) could be used to download and present a video clip posted on the Internet (e.g., using the well-known YOUTUBE video sharing service), where the video clip is a recorded version of a show that has already been broadcast.

The video services receiver 106 may include digital video recorder functionality that supports conventional video recording, storage, and playback features. Accordingly, the video services receiver 106 may include or cooperate with flash memory, a hard disk, a removable disk, or any other form of storage medium known in the art that can store recorded video content.

The server system 108 represents the hardware, software, processing logic, and architecture associated with one or more content characterization and matching services, providers, or platforms. The server system 108 may include or cooperate with a suitably configured database system that maintains, organizes, and provides data used in association with the server system 108. In this regard, the data maintained, processed, and managed by an exemplary embodiment of the server system 108 includes at least one database object for each video event of interest (i.e., the primary video content that corresponds to a video program, which may be divided into a plurality of primary video segments for purposes of inserting interstitial or secondary video content segments into the video program). This data may also include at least one database object for each piece of secondary video content of interest. For the exemplary embodiment described here, a database object for a video event (whether the event corresponds to primary video content or secondary video content) may include the following information, without limitation: a program or object identifier that uniquely identifies the video content; a title or episode name of the video event; a series title or name corresponding to the video event; an episode number or identifier; a season number or identifier; a genre or general content descriptor; a parental rating or guideline identifier; an age identifier or category that indicates a recommended or appropriate age group for the video event; a publisher, producer, or content originator; a broadcast network identifier; a channel or video service identifier; runtime indicators (which may identify the total runtime and/or the runtimes for each segment of the video event of interest); time/date stamp information related to a broadcast or presentation time of the video event; and descriptive data (metadata) that characterizes the video content.

In certain embodiments, a database object for a video event may include information (e.g., information provided by content providers) that relies on social contributions to describe or rate the material. In this regard, some of the descriptive information can be mutable, and very specific to segment. As an example, movies with actors that have fallen out of favor, or having particular social habits (such as smoking, drinking, or offensive language) can be tagged.

As mentioned above, the server system 108 maintains, manages, and processes data that is linked to (or otherwise associated with) the primary video content and the secondary video content of interest. For any given piece of video content, the corresponding data can be linked to the program identifier that uniquely identifies the piece of video content. Thus, an amount of descriptive/characterizing data can be uniquely linked to a piece of video content by way of its unique program identifier. The descriptive data for video content may include some or all of the following, without limitation: a genre, category, or classification; a parental rating; an intended audience identifier; an age identifier or category that indicates a recommended or appropriate age group for the video content; a social behavior identifier or category that indicates certain types of behavior demonstrated in the video content, e.g., smoking, drinking alcohol, drug use, etc.; a gender or sexual orientation identifier or category that indicates a recommended or appropriate gender or sexual orientation for the video content; an ethnic identifier or category that indicates a recommended or appropriate ethnic group for the video content; a nationality identifier or category that indicates a recommended or appropriate nationality group for the video content; a political identifier or category that indicates a recommended or appropriate political group for the video content; a cultural identifier or category that indicates a recommended or appropriate cultural group for the video content; an interest identifier or category that indicates a recommended or appropriate interest group for the video content; a language identifier or category that indicates a recommended or appropriate language for the video content; tags or keywords that identify scenes, themes, or subject matter of the video content; product or service identifiers associated with advertisements or commercials; manufacturer, vendor, service provider, or company names associated with advertisements or commercials; and the like.

The server system 110 represents the hardware, software, processing logic, and architecture associated with one or more content delivery services, providers, or platforms. The server system 110 may include or cooperate with a suitably configured database system that maintains, organizes, and provides replacement video content that can be used to replace video segments that appear in an original version of video programming having primary video content and secondary video content. In practice, the server system 110 may be implemented as described above for the source of video programming 102. The server system 110 may be deployed in the context of a content delivery network (CDN) or advertisement server that cooperates with the server system 108, the video services receiver 106, the presentation device 104, and the like.

For the exemplary embodiment described here, secondary video content maintained and managed by the server system 110 can be uniquely identified with corresponding program identifiers. Alternatively or additionally, there can be coordination with the presentation device 104 and/or with the video services receiver 106 to narrow the targeting and to improve the manner in which the secondary video content is selected. This allows the server system 108 to coordinate with the server system 110 to identify appropriate secondary video content to be used as replacement content and served to a destination device within the system 100. As mentioned above, the features and functionality of the server systems 108, 110 can be combined for deployment in a common hardware device or system if so desired.

Although not separately depicted in FIG. 1, the video services receiver 106, the source of video programming 102, and/or another component in the system 100 may include video place-shifting functionality, or it may cooperate with a suitably configured place-shifting device or component to place-shift video content. In this regard, it may be possible to provide live or recorded content to a remote device operated by the user (such as the presentation device 104), wherein the video services receiver 106, the source of video programming 102, and/or another component in the system 100 serves as a source of the place-shifted content.

Moreover, the video services receiver 106, the presentation device 104, and/or other devices operating in the system 100 may include any number of native video processing and rendering features and functions. In this regard, the video services receiver 106, the presentation device 104, and/or other devices in the system 100 can be suitably configured to perform the video presentation functions described in more detail herein.

The source of video programming 102, the presentation device 104, the video services receiver 106, the server system 108, and the server system 110 can be implemented as (or can be integrated with) an electronic processor-based component. Regardless of its form factor and hardware platform, a processor-based or computer-implemented device deployed in the system can be suitably configured to support the desired features and functions using the appropriate hardware, software, firmware, etc. For example, a computer-implemented device or system may include, without limitation: a network communication module to interface with the data communication network 112; device-specific hardware, software, firmware, and/or applications; at least one processor device; and at least one memory element having a suitable amount of storage capacity. The memory element can include or be realized as a non-transitory computer readable medium that is operatively associated with the processor device, wherein the medium includes executable instructions that are configurable to cause the processor device and the host device to perform the methods and processes described in more detail below.

The exemplary implementation of the system 100 utilizes program identifiers to uniquely identify video content. More specifically, the primary video content conveyed in video programming is identified by a corresponding program identifier. In certain embodiments, the secondary video content (e.g., advertisements and other interstitial content) conveyed in video programming is also identified by a corresponding program identifier. Although any suitable identification scheme, protocol, or convention can be used in the context of system 100, certain preferred implementations leverage the Entertainment Identifier Registry (EIDR), which is a universal unique identifier system for movie and television assets. Details of the EIDR platform, and a search engine to find EIDR program identifiers, are publicly available at www.eidr.org.

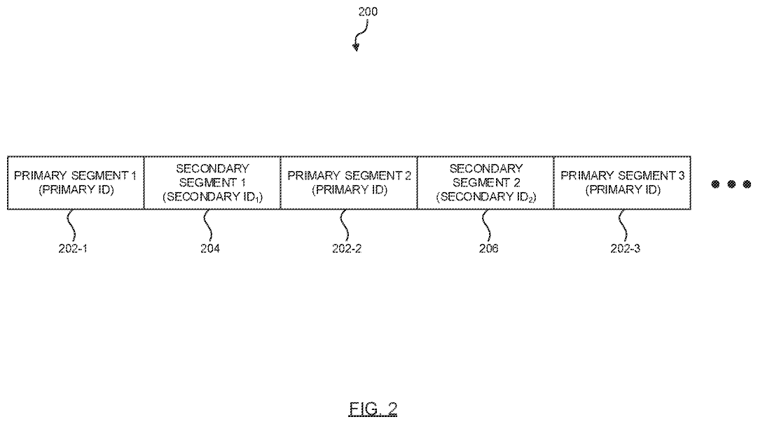

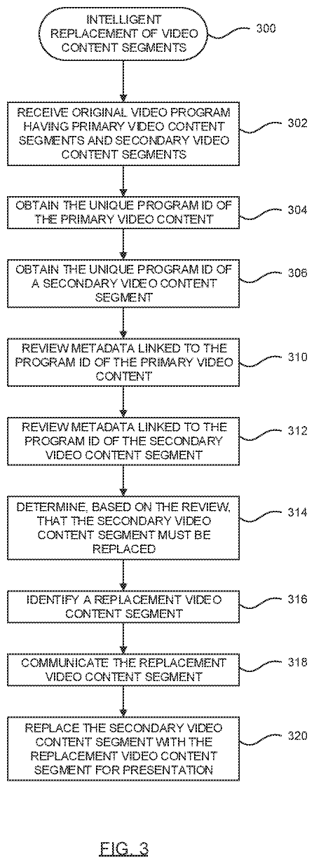

A typical use case will be described here, with reference to the video services system 100 shown in FIG. 1 and with reference to FIG. 2, which shows a schematic representation of a video program 200 having primary video segments interspersed with secondary video segments. The use case described here follows the exemplary methodology outlined in FIG. 3, which is a flow chart that illustrates an exemplary embodiment of a process 300 for the intelligent replacement of video content segments. The process 300 represents an exemplary method of operating a video services system of the type described above. The various tasks performed in connection with the process 300 may be performed by software, hardware, firmware, or any combination thereof. For illustrative purposes, the following description of the process 300 may refer to elements mentioned above in connection with FIG. 1. In practice, portions of the process 300 may be performed by different elements of the described system, e.g., a video services receiver, a client presentation device, a secondary video content server, or a content characterization and matching server. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The example presented here assumes that the various components of the system 100 are already deployed and configured for compatibility with one another to support the described features and functions. To this end, there must be agreement among content producers, video service providers, video delivery system operators, client device manufacturers, client device software developers, video services receiver manufacturers, video services receiver software developers, content delivery networks, etc., with respect to the manner in which video content is identified, the manner in which video content is characterized, tagged, or otherwise classified, and the manner in which secondary video segments that appear in an original version of video programming are replaced with replacement video segments that the system 100 deems to be suitable or appropriate for the primary video content that appears in the original version of the video programming. Moreover, the example presented here assumes that the server system 108 is already populated with a fulsome list of classified, categorized, and characterized video events, linked to their respective program identifiers and descriptive data that characterizes the video content. As mentioned above, primary video content will be linked to the corresponding descriptive data. In certain implementations, secondary video content will also be linked to its corresponding descriptive data.

In accordance with this typical use case, an original version of video programming can be provided by the source of video programming, for presentation by the video services receiver 106 or the presentation device 104. FIG. 2 schematically depicts an original version of video programming 200, which has been divided into a plurality of adjacent segments. Although only five distinct segments are depicted, the ellipses in FIG. 2 indicate that the original version of video programming 200 may contain any number of additional segments. The video programming 200 includes primary video content divided into primary video segments 202, and secondary video content provided in secondary video segments 204, 206. Each secondary video segment 204, 206 is arranged adjacent to at least one of the primary video segments 202. Although not always required, the illustrated video programming leads with a first primary video segment 202-1, which is followed by the secondary video segment 204, which is followed by a second primary video segment 202-2, which is followed by the secondary video segment 206, which is followed by a third primary video segment 202-3. The primary video content (which includes the primary video segments 202) represents the content to be viewed by the consumer, e.g., a movie, a sporting event, a television show, or a concert. The secondary video content (which includes the secondary video segments 204, 206, and possibly others) represents interstitial, commercial, advertising, promotional, or marketing content that is usually presented between two segments of primary video content.

The primary video content is uniquely identified with a primary program identifier (the Primary ID labeled in FIG. 1). As shown in FIG. 1, each primary video segment 202 includes the same primary program identifier associated therewith. In contrast, different pieces of secondary video content are uniquely identified with a respective secondary program identifier. Accordingly, FIG. 1 labels the secondary video segment 204 with “Secondary ID₁” and labels the secondary video segment 206 with “Secondary ID₂” to distinguish the two pieces of secondary video content. If the same secondary video content is repeated in both of the secondary video segments shown in FIG. 1, then the same secondary program identifier can be used in association with both of those secondary video segments.

Ideally, the secondary video segments 204, 206 convey subject matter that is suitable, correct, relevant, or otherwise appropriate for the intended or anticipated viewing audience for the primary video content. For example, if the primary video content is an educational program for young children, and the secondary video segments 204, 206 are commercials, then the commercials ought to be suitable for a young viewing audience. As another example, if the primary video content is a heavy metal concert or a baseball game, then the commercials can be directed to a demographic grouping of older, primarily male audience. The video services system 100 and operating methodologies described here are designed to address scenarios where the secondary video content does not “match” the primary video content, such that the secondary video content is inappropriate, irrelevant, uninteresting, or unsuitable for the viewers of the primary video content. These scenarios are addressed by determining suitable and appropriate replacement video content that can be presented in place of the originally provided secondary video content that appears in the original version of the video programming 200.

Referring to FIG. 3, the process 300 may begin by receiving and processing encoded video data that conveys an original version of video programming having primary video content (that is divided into primary video segments) and having secondary video content provided in one or more secondary video segments (task 302). Task 302 may be performed by the video services receiver 106 or the presentation device 104 in various implementations. The process 300 may continue by obtaining the primary program identifier that uniquely identifies the received primary video content (task 304). The primary program identifier can be conveyed with the primary video content and/or it can be communicated separately from the primary video content (as long as the system 100 can make the association between the primary video content and its program identifier). In accordance with certain embodiments, the primary program identifier is obtained from at least one timed text packet of the encoded video data that is used to convey the primary video content. For this implementation, a timed text packet includes the desired information or data to be communicated (e.g., the program identifier and/or descriptive data that characterizes the primary video content), along with metadata that links the timed text packet to the corresponding audio/video packets that convey the primary video content. Thus, each timed text packet can be synchronized with its corresponding audio/video packets at the destination device. In accordance with alternative embodiments, the primary program identifier can be communicated in association with the primary video content using techniques and methodologies that are commonly used to provide closed captioning and/or other types of metadata that is linked to video programming.

Although not always required, the illustrated embodiment of the process 300 also obtains a secondary program identifier that uniquely identifies a secondary video segment that appears in the original version of the video programming (task 306). The secondary program identifier may be communicated in at least one timed text packed of the encoded video data that is used to convey the secondary video content, in a separate data object or data stream, or the like (as described above for the primary program identifier). In accordance with the exemplary system 100 depicted in FIG. 1, the server system 108 obtains the primary program identifier and (optionally) the secondary program identifier in an appropriate manner. For example, the server system 108 can poll the video services receiver 106 or the presentation device 104 to obtain the program identifiers, or the program identifiers can be pushed out to the server system 108 from one or more components of the system 100. As another example, the program identifiers can be included with electronic program guide data, which can be provided to the server system 108 on demand or in any suitable manner.

The processing and methodology associated with task 306 can happen very quickly when using IP based systems. A content system can use a section of the packets to look ahead (which can be a simple insertion in the metadata such as “secondary content in ten seconds”). The polling is then processed in the background so the content is ready when the viewer is ready. In legacy systems, a content creator may not have much control over where secondary content is inserted. By allowing this signal, any primary content provider can drop in the code that allows secondary content when they want. This functionality can be implemented with code that beacons to the systems to add commercials.

In certain embodiments, a manifest can be included with the content at start, where the manifest (which would be part of the content metadata) details when commercial breaks are included. This information can identify where metadata fields exist in Video on Demand (VOD), and where a content provider indicates if commercial insertion is allowed. This information may also indicate when commercials can be inserted, utilizing timing data included in the content (e.g., timed text that maintains synchronization between closed captioning and content), colorimetric information, or the like. If a viewer tunes in after content has started, there can be a separate set of codes queuing the insertion (as a backup and independent) so that the commercial can be inserted on time, and with the correct duration. In normal over the air programming, this manifest is programmed into the content distribution systems. This manifest can also stipulate the kind of advertisements that would be of interest to the common user group or restrictions. For instance, some religious programming may stipulate that no alcohol can be advertised in that block.

The use of secondary program identifiers is optional because the actual subject matter of the original secondary video content may be a “don't care” condition of the system 100. More specifically, the system 100 may be configured to determine suitable and appropriate replacement video content for the original version of the video programming and provide that replacement video content for insertion between segments of primary video content regardless of the actual content that is conveyed in the original secondary video segments. In this regard, a replacement video segment may replace an inappropriate video segment or an already appropriate video segment, depending on the situation. Secondary program identifiers are helpful to identify whether or not an originally provided secondary video segment is appropriate for the intended consumer of the primary video content.

The process 300 may continue by reviewing information (e.g., metadata, descriptive data, contextually relevant data) that is linked to the obtained primary program identifier (task 308). As an optional feature, the process 300 may also review information (e.g., metadata, descriptive data, contextually relevant data) that is linked to the obtained secondary program identifier (task 310). As explained above, each program identifier is preferably maintained at the server system 108 in association with a respective database object that includes a variety of information related to the video content that is linked to that particular program identifier. Thus, the system 100 uses the program identifiers to access, review, and otherwise process the information that characterizes, describes, classifies, or summarizes the associated video content (which may be primary video content or secondary video content).

In contrast to traditional systems, the identification and matching of content can occur in real time or substantially real time. Thus, the matching methodology can consider what the viewer watched before the current programming, what the viewer is channel switching to and from, etc. In contrast, some existing systems process data in the back end to consider what was most likely to be the viewer, based on demographics.

The descriptive data that characterizes the primary video content and (optionally) the descriptive data that characterizes the secondary video content is reviewed and analyzed to determine whether a secondary video segment that appears in the original version of the video programming must be replaced with alternative video content. This determination can consider user data. For instance, the user device may have data that the prior program was a children's program, or a user is changing channels between a children's program and a sporting event. In that case, secondary content that is appropriate for children could be inserted. If a user is viewing the content during late night, the secondary content could be more adult oriented. Moreover, a device may be set to not share any user data, in which case the system would consider matching secondary programing to primary programing, the time of day content is being viewed, the operating mode (DVR, live), or network (Mobile or STB) to estimate optimal secondary content.

In practice, the process 300 can consider some or all of the descriptive data linked to the primary video content for purposes of identifying suitable replacement video content having descriptive data that matches or is otherwise compatible with the descriptive data of the primary video content. Alternatively or additionally, the process 300 can compare the descriptive data linked to the primary video content against the descriptive data linked to the originally provided secondary video content to determine a level of compatibility, appropriateness, or matching. This example assumes that the process 300 determines, based on the review of the descriptive data, that the originally provided secondary video segment must be replaced with alternative video content (task 312).

The process 300 continues by identifying an appropriate replacement video segment to replace the originally provided secondary video segment (task 314). Task 314 may be carried out by searching for video content having descriptive data that better matches the descriptive data linked to the primary video content. In this regard, this example assumes that the replacement video segments have already been pre-characterized and linked to corresponding descriptive data. Thus, the identifying step determines that a replacement video segment is appropriate for an intended viewing audience of the primary video content. Depending on the particular implementation and system configuration, the identifying step may be executed to determine whether the primary video content and the replacement video segment are intended for similar age, gender, ethnic, political, cultural, social, or interest groups.

This example assumes that the process 300 identifies at least one suitable video segment that can serve as a replacement video segment. If a plurality of candidate video segments are found, then the process 300 can select one using any selection criteria, e.g., the best “match”, the newest video segment, the most popular or highest ranked video segment, or the like. The process 300 continues by communicating the replacement video segment to the desired destination device (task 316). For the exemplary embodiment described here, the replacement video segment is communicated from the secondary content server system 110 in response to the determination made by the server system 108. However, the actual source of the replacement video segment will depend on the particular implementation and configuration of the system 100.

The replacement video segment can be communicated to the presentation device 104, the source of video programming 102, the video services receiver 106, and/or another component or device operating within the system 100. The replacement video segment is communicated to replace the secondary video segment that appears in the original version of the video programming. Thus, during presentation at the user presentation device 104, the replacement video segment is played instead of the secondary video segment. Note that this communicating step may not be required in all cases—if the replacement video segment is already resident at the destination device or the client presentation system, then it need not be communicated between distinct hardware devices.

The process 300 continues by replacing the original secondary video segment with the communicated replacement video segment (task 318). Accordingly, the presentation device can be operated to present the primary video segments (included with the original version of the video programming) and the replacement video segment (in lieu of the original secondary video segment included with the original version of the video programming). The replacement step may be performed by the presentation device 104, the video services receiver 106, the source of video programming 102, or another component or device operating within the system 100. Regardless of where the replacement takes place, the viewer is presented with the primary video content and secondary video content that is appropriate, relevant, or otherwise related to the primary video content. Furthermore, the user experience is seamless. In theory, a viewer can see the same program multiple times. If the system has indicated the secondary content is available for replacement, the user experience would be different (in each viewing).

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of operating a video services system, the method comprising the steps of:
processing encoded video data that conveys an original version of video programming having primary video content divided into primary video segments, and having secondary video content in a secondary video segment arranged adjacent to at least one of the primary video segments;
obtaining a primary program identifier that uniquely identifies the primary video content;
reviewing information linked to the obtained primary program identifier to identify characteristics of the primary video content;
in response to the reviewing, identifying a replacement video segment having characteristics that match the characteristics of the primary video content to replace the secondary video segment;
replacing the secondary video segment with the replacement video segment; and
providing a media stream for presentation to a viewer, wherein the media stream comprises the primary video segments and the replacement video segment.

2. The method of claim 1, wherein the secondary video content comprises advertising, marketing, promotional, or commercial content.

3. (canceled)

4. The method of claim 1, wherein the information linked to the first program identifier comprises descriptive data that characterizes the primary video content.

5. The method of claim 1, wherein the identifying step determines that the replacement video segment is appropriate for an intended viewing audience of the primary video content.

6. The method of claim 5, wherein the identifying step determines that the primary video content and the replacement video segment are intended to attract consumers that are likely of similar age, gender, ethnic, political, cultural, social, or interest groups.

7. The method of claim 1, further comprising the steps of:
obtaining a second program identifier that uniquely identifies the secondary video content; and
reviewing information linked to the second program identifier; and
determining, based on results of reviewing the information linked to the obtained primary program identifier and the information linked to the second program identifier, that the secondary video content must be replaced with alternative video content.

8. The method of claim 7, wherein the information linked to the second program identifier comprises descriptive data that characterizes the secondary video content.

9. The method of claim 1, wherein the obtaining step obtains the primary program identifier from at least one timed text packet of the encoded video data.

10. The method of claim 1, wherein:
the processing and replacing steps are performed by a user presentation device; and
the obtaining, reviewing, and identifying steps are performed by at least one remote computing device that communicates with the user presentation device over a network.

11. A computer-implemented video processing system to process encoded video data that conveys an original version of video programming having primary video content divided into primary video segments, and having secondary video content in a secondary video segment arranged adjacent to at least one of the primary video segments, the video processing system comprising:
at least one processor device; and
non-transitory computer readable media operatively associated with the at least one processor device, the computer readable media comprising executable instructions configurable to cause the at least one processor device to perform a method comprising the steps of:
obtaining a primary program identifier that uniquely identifies the primary video content;
reviewing information linked to the obtained primary program identifier to identify characteristics of the primary video content;
in response to the reviewing, identifying a replacement video segment having characteristics that match the characteristics of the primary video content to replace the secondary video segment; and
communicating the replacement video segment to replace the secondary video segment during presentation at a user presentation device.

12. The system of claim 11, wherein the secondary video content comprises advertising, marketing, promotional, or commercial content.

13. The system of claim 11, wherein the information linked to the first program identifier comprises descriptive data that characterizes the primary video content.

14. The system of claim 11, wherein the identifying step determines that the replacement video segment is appropriate for an intended viewing audience of the primary video content.

15. The system of claim 11, wherein the obtaining step obtains the primary program identifier from at least one timed text packet of the encoded video data.

16. A method of operating a video services system configured to process encoded video data that conveys an original version of video programming having primary video content divided into primary video segments, and having secondary video content in a secondary video segment arranged adjacent to at least one of the primary video segments, the method comprising the steps of:
obtaining a primary program identifier that uniquely identifies the primary video content;
reviewing information linked to the obtained primary program identifier to identify characteristics of the primary video content;
in response to the reviewing, identifying a replacement video segment having characteristics that match the characteristics of the primary video content to replace the secondary video segment; and
communicating the replacement video segment to replace the secondary video segment during presentation at a user presentation device.

17. The method of claim 16, wherein the secondary video content comprises advertising, marketing, promotional, or commercial content.

18. The method of claim 16, wherein the information linked to the first program identifier comprises descriptive data that characterizes the primary video content.

19. The method of claim 16, wherein the identifying step determines that the replacement video segment is appropriate for an intended viewing audience of the primary video content.

20. The method of claim 15, wherein the obtaining step obtains the primary program identifier from at least one timed text packet of the encoded video data.
